(19) United States
(12) Patent Application Publication
(10) Pub. No.: US 2011/0232581 A1
(43) Pub. Date: Sep. 29, 2011

(54) Pet Toy

(75) Inventor: James W. Gick, Laguna Niguel, CA (US)

(73) Assignee: Pet Qwerks, Inc.

(21) Appl. No.: 13/070,341

(22) Filed: Mar. 23, 2011

Related U.S. Application Data
(60) Provisional application No. 61/317,437, filed on Mar. 25, 2010.

(51) Int. Cl. A01K 15/02; A01K 29/00

(52) U.S. Cl. 119/707

(57) ABSTRACT

A pet toy as described has a front side and a back side and is defined by a perimeter element that is generally rubber, urethane or other suitable material. The perimeter element surrounds at least one recess formed on each side of the toy, the recesses forming a flexible membrane between them. One or both surfaces of the membrane has a layer of felted cloth or other fabric secured to the surface. The flexibility of the membrane, combined with the depth of the recesses increases the difficulty for a dog to securely grip the felted cloth and separate it from the pet toy.

### RELATED APPLICATIONS

This application claims priority from copending U.S. Provisional patent application 61/317,437 filed Mar. 25, 2010.

### FIELD OF THE INVENTIONS

The inventions described below relate to the field of pet toys and specifically to the field of throwable chew toys for dogs.

### BACKGROUND OF THE INVENTIONS

Stimulating pets to maintain their health is often achieved by providing toys for the pet to chase, chew or otherwise interact with. Dogs often destroy toys they chew.

### SUMMARY

A pet toy as described below has a front side and a back side and is defined by a perimeter element or elements that are generally rubber, urethane or other suitable material. The perimeter element surrounds at least one recess formed in one or both sides of the toy, the recesses forming a flexible membrane between them. One or both surfaces of the membrane has a layer of felted cloth or other fabric secured to the surface. The flexibility of the membrane, combined with the depth of the recesses increases the difficulty for a dog or other animal to securely grip the felted cloth and separate it from the pet toy.

The perimeter element may be formed to look like an automobile or other tire with any suitable tread pattern and the perimeter element may be hollow.

Other design features may be incorporated in the pet toy to increase attractiveness to the pet or the owner. One or more protruding elements may extend from either the front or back side, or from both sides of the pet toy.

The perimeter element may have one or more embellishments attached, secured or co-molded to the perimeter element. The perimeter element may also include a recessed channel along the perimeter of the pet toy. The perimeter channel may also be lined with felt or other cloth.

### BRIEF DESCRIPTION OF THE DRAWINGS

FIG. 1 is a front view of a pet toy.

FIG. 2 is a front view of a heart shaped pet toy.

FIG. 3 is a front view of a tire shaped pet toy.

FIG. 4 is a front view of a bone shaped pet toy.

FIG. 5 is a cross section view of the pet toy of FIG. 1 taken along line A.

FIG. 6 is a cross section view of the pet toy of FIG. 2 taken along line B.

FIG. 7 is a cross section view of the pet toy of FIG. 4 taken along line D.

FIG. 8 is a cross section view of the pet toy of FIG. 3 taken along line C.

FIG. 9 is an alternate cross section view of the pet toy of FIG. 3 taken along line C.

FIG. 10 is a cross section view of a perimeter element showing the recessed perimeter channel.

FIG. 11 is a front view of a top shaped pet toy.

FIG. 12 is a front view of an embedded star pet toy.

FIG. 13 is a front view of an embedded ball pet toy.

FIG. 14 is a cross section view of the pet toy of FIG. 11 taken along line E.

FIG. 15 is a cross section view of the pet toy of FIG. 12 taken along line F.

FIG. 16 is an alternate cross section view of the pet toy of FIG. 12 taken along line F.

FIG. 17 is a cross section view of the pet toy of FIG. 13 taken along line G.

FIG. 18 is a perspective view of a pet toy with a ribbed perimeter element.

FIG. 19 is a cross-section view of the pet toy of FIG. 18.

### DETAILED DESCRIPTION OF THE INVENTIONS

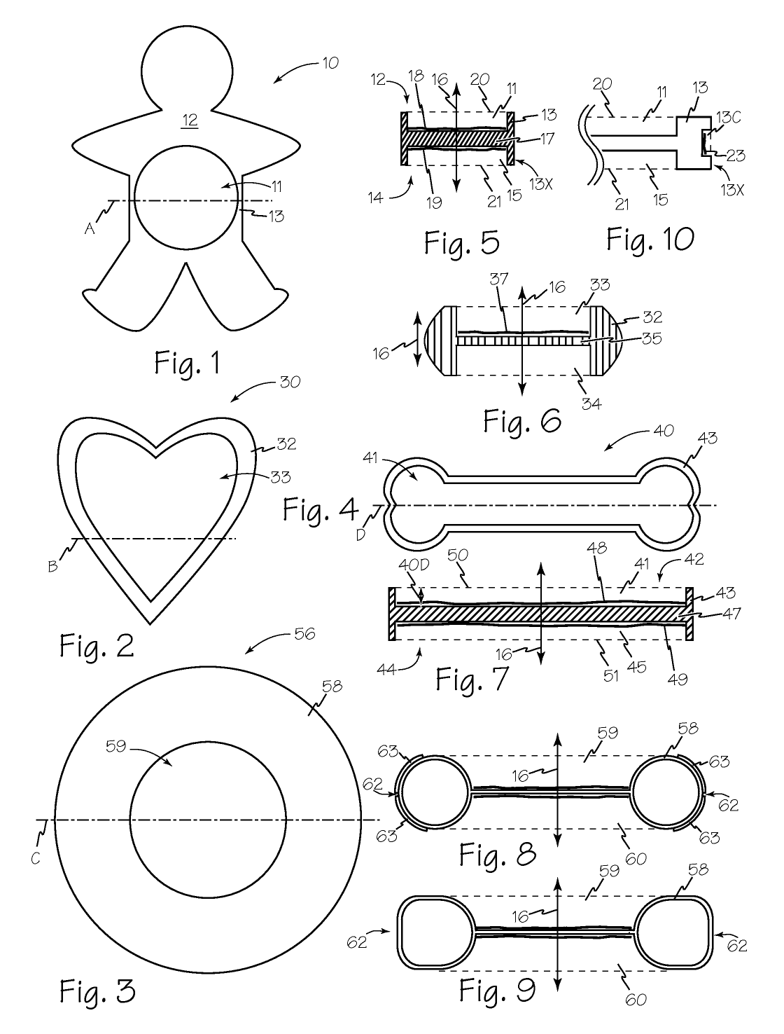

Pet toy 10 of FIGS. 1 and 5 includes first recess 11 in first or front side 12. Second or back side 14 includes second recess 15. First recess 11 and second recess 15 are surrounded by perimeter element 13 and have a depth measured parallel to axis 16, where the depth is sufficient to maintain fabric layers 18 and 19 below imaginary surfaces 20 and 21 respectively. First recess 11 and second recess 15 are oriented in coaxial opposition with respect to axis 16 and they form membrane 17 between them. Fabric layers 18 and 19 are secured to membrane 17 using any suitable adhesive or attachment technique.

Referring now to FIG. 10, in an alternate configuration perimeter element 13 may include channel 13C in outer surface 13X. Channel 13C may also include a fabric layer such as fabric layer 23 completely within channel 13C.

Referring now to FIGS. 2 and 6, pet toy 30 has a heart shaped perimeter element 32 surrounding front recess 33 and rear recess 34. Membrane 35 is formed between front and rear recesses 33 and 34. Front recess 33 includes fabric layer 37 secured to membrane 35.

Pet toy 40 of FIGS. 4 and 7 includes perimeter element 43 surrounding first recess 41 in front side 42. Back side 44 includes second recess 45. First recess 41 and second recess 45 have a depth measured parallel to axis 46 where depth 40D is sufficiently deep to maintain fabric layers 48 and 49 below imaginary surfaces 50 and 51 respectively. First recess 41 and second recess 45 form membrane 47 between them. Fabric layers 48 and 49 are secured to membrane 47 using any suitable adhesive or attachment technique.

Referring now to FIGS. 3, 8 and 9, tire shaped pet toy 56 includes hollow perimeter element 58 defining first recess 59 and second recess 60. Perimeter element 58 may be hollow to reduce weight and provide a more bouncy, active pet toy. Perimeter element 58 may have a circular cross section as illustrated in FIG. 8, or it may adopt a more complex shape as illustrated in FIG. 9. Rolling surface 62 may include raised structures such as treads 63. Treads, ribs or any suitable shapes may be adopted for raised structures 63.

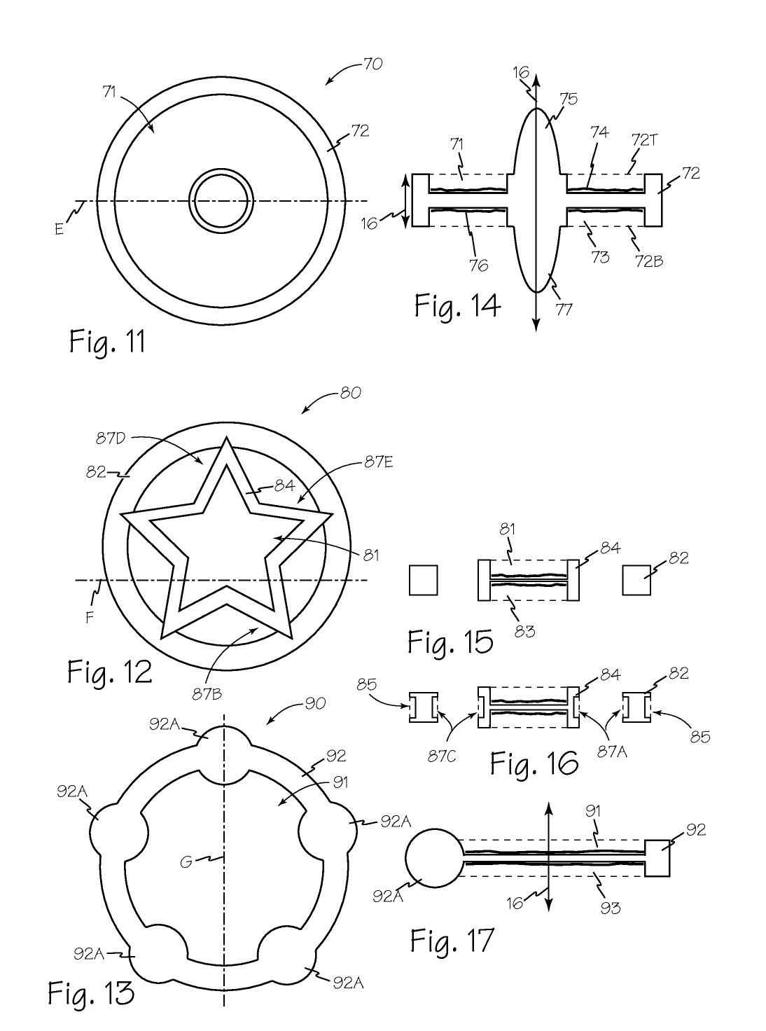

Referring now to FIGS. 11 and 14, pet toy 70 includes perimeter element 72 defining first recess 71 and second recess 73. One or more protruding element such as extensions 75 and 77 may extend beyond imaginary surfaces 72T and 72B parallel to axis 16. First and second fabric layers 74 and 76 may be secured within first and second recesses 71 and 73 respectively.

Referring now to FIGS. 12, 15 and 16, pet toy 80 is shown. Pet toy 80 includes first perimeter element 82 and second perimeter element 84. Second perimeter element 84 defines first and second recess volumes 81 and 83 respectively. In a first configuration, first and second perimeter elements 82 and 84 have solid rectangular cross-sections as shown in FIG. 15. In an alternate configuration, either or both of first and second perimeter elements 82 and 84 may include an inner and or an outer channel such as channels 85 and 87. The relative shapes of first and second perimeter elements 82 and 84 may result in inner channel 87 having multiple sections such as channel sections 87A, 87B, 87C, 87D and 87E. Either or both channels may include a felted cloth fabric layer secured in the channel as in the recess volumes.

Referring now to FIGS. 13 and 17, pet toy 90 is shown. Perimeter element 92 may include one or more embellishments such as embedded spheres 92A which extend beyond the surfaces of the perimeter element. As discussed above, first and second recesses 91 and 93 respectively may each include a fabric liner secured within the recesses.

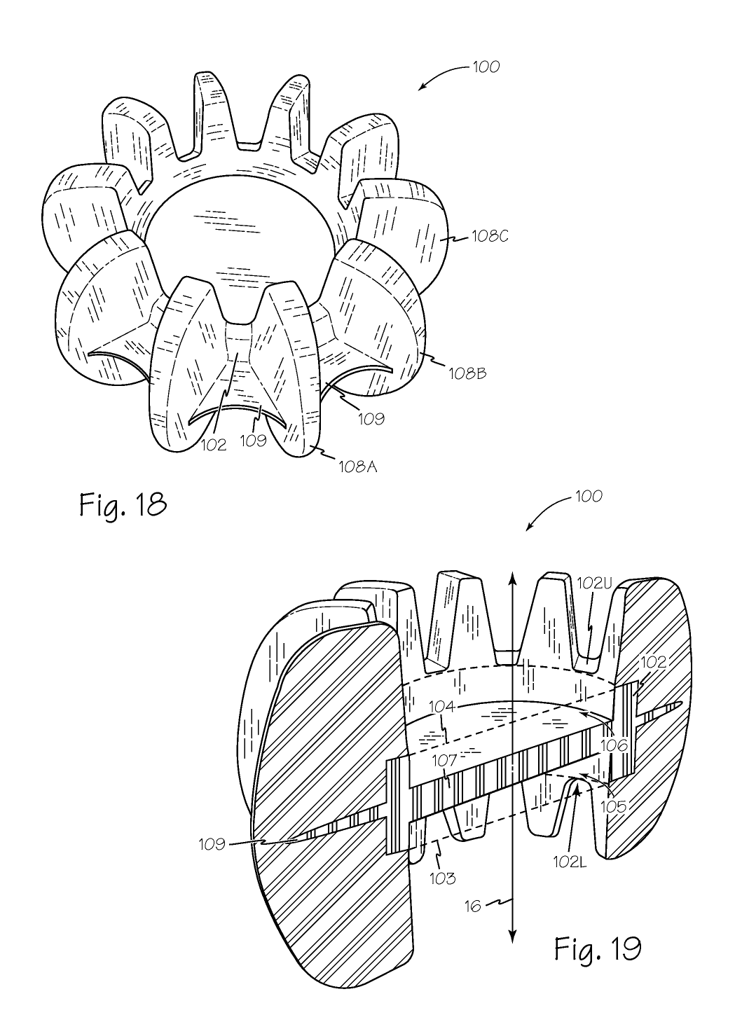

Referring now to FIGS. 18 and 19, pet toy 100 includes perimeter element 102 which has upper or first surface 102U and lower or second surface 102L. Upper and lower surfaces 102U and 102L each define first and second imaginary surfaces 103 and 104 respectively which enclose first and second recess volumes 105 and 106 respectively. First recess 105 and second recess 106 are oriented in coaxial opposition with respect to axis 16 and they form membrane 107 between them. As discussed above, perimeter element 102 is attached to one or more embellishments such as fins 108A, 108B and 108C. Web 109 extends between adjacent fins. Perimeter element 102, membrane 107 and web 109 may be formed of the same material, and fins 108 may be formed of the same or different material.

While the preferred embodiments of the devices and methods have been described in reference to the environment in which they were developed, they are merely illustrative of the principles of the inventions. Other embodiments and configurations may be devised without departing from the spirit of the inventions and the scope of the appended claims.

We claim:

1. A pet toy comprising:
a perimeter element having an upper and lower surfaces, the perimeter element surrounding one or more recessed areas below an imaginary surface extending across the upper and lower surfaces of the perimeter element; and
a layer of cloth bonded within at least one of the one or more recessed areas and below the imaginary surface.

2. The pet toy of claim 1 further comprising:
a plurality of embellishments attached to the perimeter elements.

3. The pet toy of claim 2 wherein the embellishments are spherical.

4. The pet toy of claim 2 wherein the embellishments are fins.

5. The pet toy of claim 5 further comprising:
a plurality of webs, each web secured between adjacent fins.

6. The pet toy of claim 1 further comprising:
an outer surface of the perimeter element; and
a channel in the outer surface of the perimeter element.

7. The pet toy of claim 6 further comprising:
a layer of cloth bonded within the channel.

8. A pet toy comprising:
a perimeter element defining first and second recesses, the first and second recesses in coaxial opposition forming a membrane between them;
a layer of cloth bonded to the membrane within at least one of the recesses.

9. The pet toy of claim 8 further comprising:
a plurality of embellishments attached to the perimeter elements.

10. The pet toy of claim 9 wherein the embellishments are spherical.

11. The pet toy of claim 9 wherein the embellishments are fins.

12. The pet toy of claim 11 further comprising:
a plurality of webs, each web secured between adjacent fins.

13. The pet toy of claim 8 further comprising:
an outer surface of the perimeter element; and
a channel in the outer surface of the perimeter element.

14. The pet toy of claim 13 further comprising:
a layer of cloth bonded within the channel.
